(19) United States
(12) Patent Application Publication
(10) Pub. No.: US 2024/0248068 A1
(43) Pub. Date: Jul. 25, 2024

(54) Flow division accessory, analysis equipment, and flow division method using the same

(71) Applicant: Po-Jui Su, Taichung City (TW)

(72) Inventor: Po-Jui Su, Taichung City (TW)

(21) Appl. No.: 18/511,637

(22) Filed: Nov. 16, 2023

(30) Foreign Application Priority Data
Jan. 19, 2023 (TW) 112102497

(51) Int. Cl. G01N 30/38; G01N 30/72

(52) U.S. Cl. CPC G01N 30/38; G01N 30/7233; G01N 2030/027

(57) ABSTRACT

The present invention provides a flow division accessory, analysis equipment, and flow division method using the same. It uses a design that pumps an amount of liquid sample by the flow division method to make the analysis equipment less susceptible to affect its accuracy by the changes in the flow rate of the liquid sample even when coupled with chromatography equipment, and analyzes the types and states of different components in the liquid sample at the same time.

### FIELD OF THE INVENTION

The present invention is related to a flow division accessory used in analytical equipment, more particularly to a flow division accessory suitable for raw material analysis equipment analyzing the raw material contains semiconductor grade extremely small amounts of molecule or atom.

### BACKGROUND OF THE INVENTION

Inductively coupled plasma (ICP) has been applied to the detection of elemental emission spectra since the late 19th century AD, and since its detection limit can reach the parts per billion (ppb) grade, it provides a breakthrough development for many elemental analysis techniques and makes the technique rapidly become one of the important techniques in the field of trace element analysis.

However, although this technique has the advantage of being able to detect extremely low trace elements, it is still common for commercial models nowadays to have an equipment signal that is susceptible to change with the variation of sample-feeding flow rate, which affects the accuracy. The ICP cannot analyze the detailed elemental types and state of samples which contain many different analytical components unless used with a chromatographic tube column. However, the ICP equipment signal is very susceptible to being affected by the flow rate when it is connected to the column. In addition, each analysis needs a batch dilution of samples, making the overall analysis procedure cumbersome and susceptible to various factors that may affect accuracy when operating, in practice, for obtaining an accurate test result.

### SUMMARY OF THE INVENTION

In order to solve the current inductively coupled plasma instrument signal is susceptible to change with the variation of sample-feeding flow rate and the problem of overall analysis steps are cumbersome. The present invention provides a flow division accessory used in the first analysis equipment, which comprises: a three-way manifold, which contains a feeding line connected to the fluid, a first discharging line and a second discharging line; and a pumping device contains a feeding port and a discharging port, the feeding port and the second discharging line are in liquid communication.

In accordance, the present invention also provides an analysis equipment and method using the flow division accessory as mentioned above.

In accordance, the flow division accessory of the present invention pumps the quantitative liquid sample by dividing the flow, so that the accuracy of the analysis equipment would not be easily affected by the change of liquid sample flow rate even with the chromatography equipment, and it also can analyze the types and states of different components in the sample at the same time.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a schematic diagram of the first preferred embodiment of the flow division accessory of the present invention;

FIG. 2 is a schematic diagram of the second preferred embodiment of the flow division accessory of the present invention;

FIGS. 3˜6 are the schematic diagrams of the first to fourth preferred embodiments of the analysis equipment and flow division method of the invention with the flow division accessory; and

FIG. 7 is the result of the time corresponding to the penetration concentration of trivalent chromium (Cr³⁺) in the liquid sample analyzed in Tables 3-1 to 3-4.

FIG. 8 is the result of the time corresponding to the penetration concentration of trivalent chromium (Cr³⁺) in the mixture of trivalent and hexavalent chromium in the chromate (Cr₂O₇²⁻) liquid sample analyzed in Table 4.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

### Embodiment 1 of Division Accessory

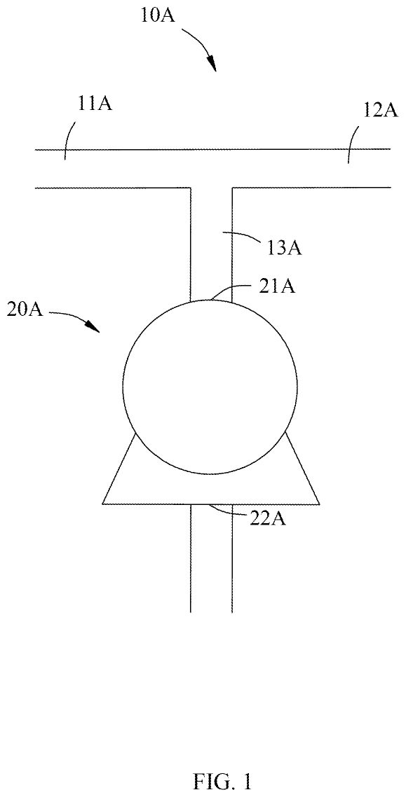

Referring to FIG. 1, the first preferred embodiment of the division accessory provided by the present invention comprises a three-way manifold 10A, which contains a feeding line 11A connected to the fluid, a first discharging line 12A, and a second discharging line 13A.

A pumping device 20A contains a feeding port 21A and a discharging port 22A, the feeding port 21A and the second discharging line 13A are in liquid communication. The pumping device 20A can preferably be a diaphragm pump, peristaltic pump, piston pump, or ventilator tube.

### Embodiment 2 of Division Accessory

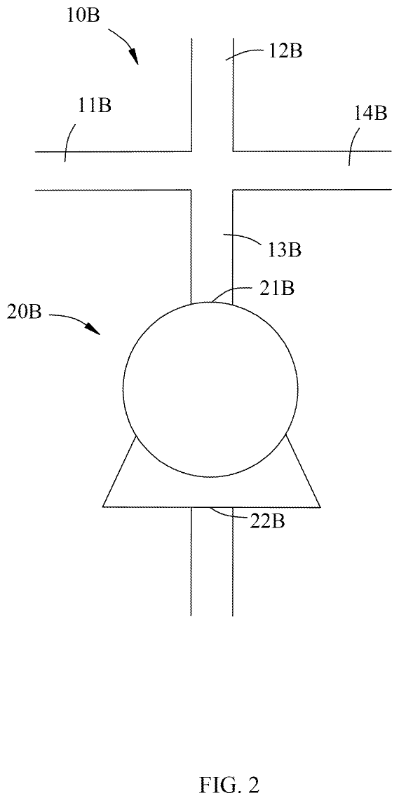

Referring to FIG. 2, the second preferred embodiment of division accessory provided by the present invention comprises a four-way manifold 10B, which contains a first feeding line 11B connected to the fluid, a second feeding line 12B, a first discharging line 13B, and a second discharging line 14B.

A pumping device 20B contains a feeding port 21B and a discharging port 22B, the feeding port 21B and the second discharging line 13B are in liquid communication. The pumping device 20B also can be a diaphragm pump, peristaltic pump, piston pump, or ventilator tube preferably.

### Embodiment 1 of Analysis Equipment and Flow Division Method with Flow Division Accessory

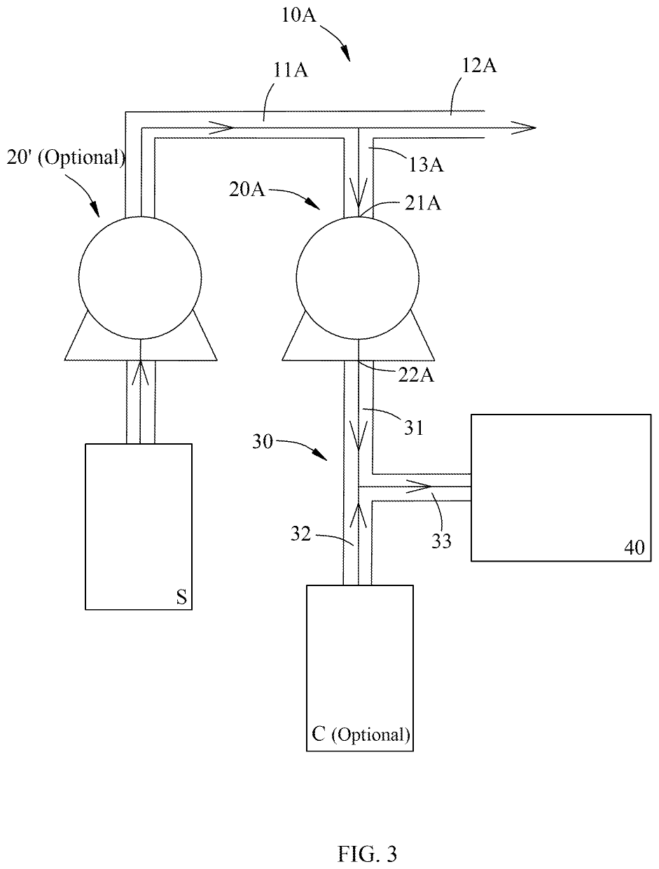

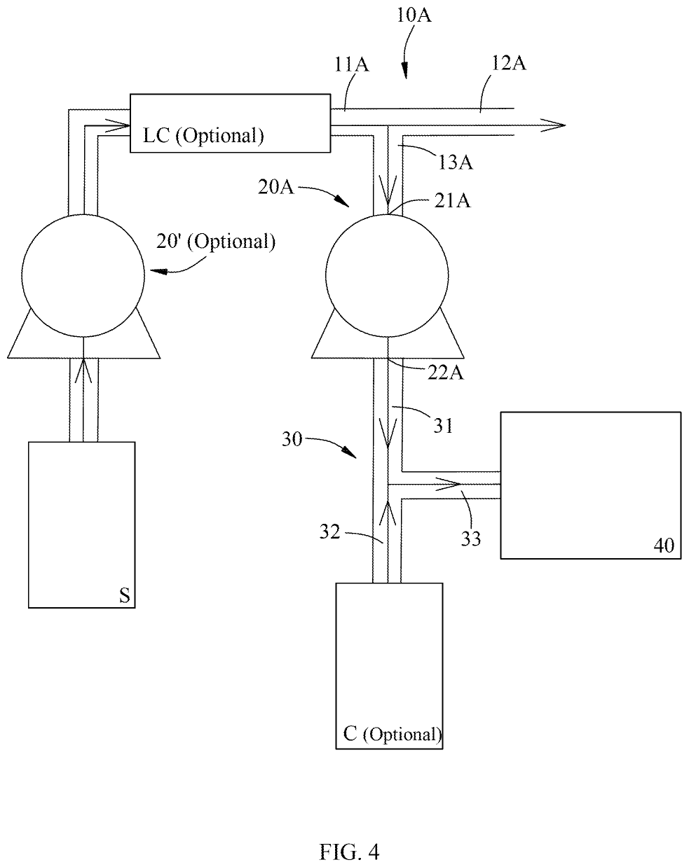

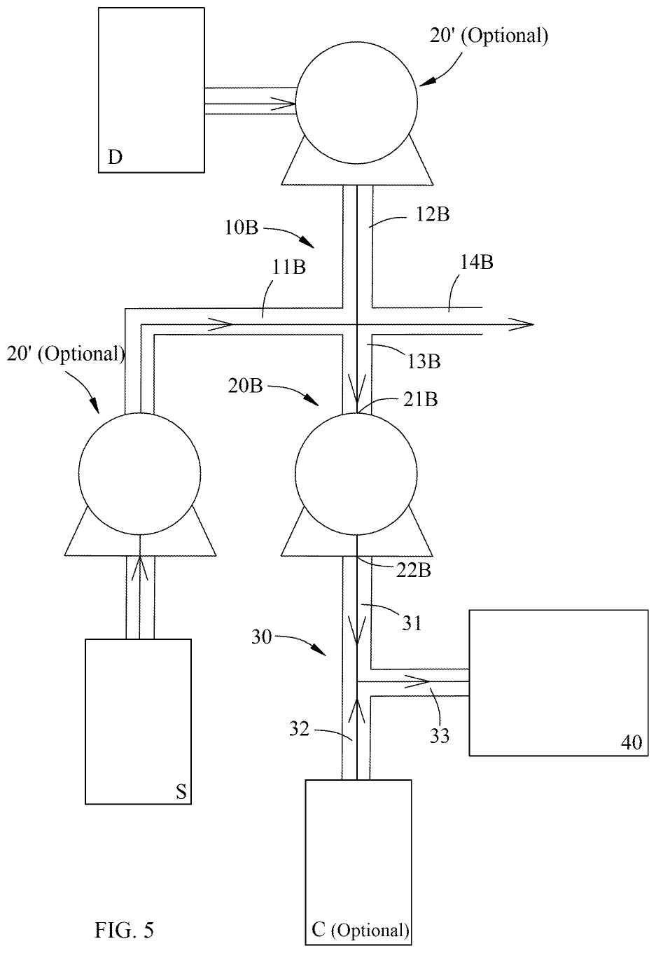

Corresponding to the aforementioned flow division accessory Embodiment 1, the method of flow division with analysis equipment 40 comprises the following. As shown in FIG. 3, Embodiment 1 of the division accessory is paired with an inductively coupled plasma mass spectrometer (ICP-MS) as the analysis equipment 40.

Step 1) Conduct a liquid sample S to introduce into the feeding line 11A of the three-way manifold 10A. Preferably, after pumping the liquid sample S into the feeding line 11A through the force generated by the pumping device 20A, some of the liquid sample S is led into the first discharging line 13A and into the pumping device 20 through the pre-set feeding volume of the pumping device 20, and the remaining liquid sample S is led out from the second discharging line 12A; and

Step 2) The liquid sample S is pumped from the feeding port 21A of the pumping device 20A and discharged from the discharging port 21A to another three-way manifold 30, which contains a first three-way feeding line 31, a second three-way feeding line 32, and a three-way discharging line 33. The liquid sample S is led from the discharging port 22A to the first three-way feeding line 31 and then flown by the three-way discharging line 33 into the analysis equipment 40 for analysis.

Preferably, the value differences between the flow rate or pressure value of the liquid sample S in the first discharging line 12A and the flow rate or pressure value of the liquid sample S from the discharging port 22A into the first three-way feeding line 31 remain similar or equal, so that the overall flow rate of the liquid sample S into the analysis equipment 40 will be stable and uniform, and the analysis signal will not be easily affected by drastic variation in flow rate.

On the other hand, since the core technology provided by the present invention is the flow division accessory and the flow division method before the liquid entry into the analysis equipment 40, the analysis equipment 40 used is the same as all commercially available, and therefore the analysis performed by the analysis equipment 40 will not be repeated in the present invention.

Further, before analyzing the liquid sample S, one or several standard samples C can be introduced through the second three-way feeding line 32 and likewise, through the three-way discharging line 33 into the analysis equipment 40 to produce a Calibration curve as a standard for subsequent analyzing of the liquid sample S, and the liquid sample S is then introduced into the analysis equipment 40 for analysis by the aforementioned method and steps thereafter.

Preferably, in order to enable the liquid sample S and the standard samples C to be analyzed separately, the first three-way feeding line 31 and the second three-way feeding line 32 are provided with as witching valve (as shown) at the junction to selectively allow only the liquid sample S or the standard samples C to pass through the three-way discharging line 33 and enter the analysis equipment 40 for analysis.

On the other hand, optionally, before the liquid sample S enters the feeding line 11A, another pumping device 20′ can be used to increase the pumping force of the liquid sample S to avoid the problem of insufficient pumping force and insufficient flow rate of the pumping device 20 set behind the three-way manifold 10A, and the pumping device 20′ therein can be a diaphragm pump, a peristaltic pump, a piston pump, a ventilator tube, or a pressure cylinder.

### Embodiment 2 of Analysis Equipment and Flow Division Method with Flow Division Accessory

Referring to FIG. 4, the overall equipment and device of this embodiment are the same as that of Embodiment 1, except that the liquid sample S passes through a liquid chromatography column LC before being introduced into the three-way manifold 10A. The liquid chromatography column LC includes, but is not limited to, anion-, cation-, or amphoteric ion-sensitive chromatography columns, and through the anion or cation adsorption effect of the liquid chromatography column LC, the type and state of the various components of the liquid sample S can be further confirmed.

As in the previous embodiment, before analyzing the liquid sample S, one or several standard samples C can be introduced through the second three-way feeding line 32 and likewise, through the three-way discharging line 33 into the analysis equipment 40 to produce a Calibration curve as a subsequent standard for the liquid sample S, and the liquid sample S is then introduced into the analysis equipment 40 for analysis by the aforementioned method and steps thereafter.

Optionally in this embodiment, before the liquid sample S enters the feeding line 11A, another pumping device 20′ can be used to increase the pumping force of the liquid sample S to avoid the problem of insufficient pumping force and insufficient flow rate of the pumping device 20 set behind the three-way manifold 10A.

### Embodiment 3 of Analysis Equipment and Flow Division Method with Flow Division Accessory

Referring to FIG. 5, corresponding to the aforementioned flow division accessory Embodiment 2, the method of flow division with analysis equipment 40 comprises the following. Embodiment 2 of the division accessory is paired with an inductively coupled plasma mass spectrometer (ICP-MS) as the analysis equipment 40. This embodiment is preferably suitable for the liquid sample S where further dilution is required.

Step 1) Conduct a liquid sample S to introduce into the first inlet line 11B of the four-way manifold 10B;

Step 2) Conduct a diluent D to introduce into the second feeding line 12B of the four-way manifold 10B;

Preferably, the liquid sample S and the diluent D are pumped into the first feeding line 11B through the force generated by the pumping device 20B, and then some of the liquid sample S and the diluent D are led into the first discharging line 13B and into the pumping device 20 by the pre-set feeding volume of the pumping device 20, and the remaining liquid sample S and the diluent D are led out from the second discharging line 14B; and

Step 3) The diluted liquid sample S of the pre-set volume is pumped from the feeding port 21B of the pumping device 20B and discharged from the discharging port 22B to the three-way manifold 30, which also contains the first three-way feeding line 31, the second three feeding line 32, and the three-way discharging line 33, and the diluted liquid sample S is led from the discharging port 22B into the first three-way feeding line 31 and then through the three-way discharging line 33 to the analysis equipment 40 for analysis.

Also, this embodiment is preferably in that the value differences between the flow rate or pressure value of the diluted liquid sample S in the first discharging line 13B and the flow rate or pressure value of the liquid sample S from the discharging port 22B into the first three-way feeding line 31 remain similar or equal, so that the overall flow rate of the liquid sample S into the analysis equipment 40 will be stable and uniform, and the analysis signal will not be easily affected by drastic variation in flow rate.

Also, before analyzing the diluted liquid sample S of this embodiment, one or several standard samples C can be introduced through the second three-way feeding line 32 and likewise, through the three-way discharging line 33 into the analysis equipment 40 to produce a Calibration curve as a standard for subsequent analyzing of the liquid sample S, and the liquid sample S is then introduced into the analysis equipment 40 for analysis by the aforementioned method and steps thereafter.

Optionally, before the liquid sample S and the diluent D enter the first feeding line 11B and the second feeding line 12B of this embodiment, another pumping device 20′ can be used to increase the pumping force of the liquid sample S and the diluent D to avoid the problem of insufficient pumping force and insufficient flow rate of the pumping device 20 set behind the four-way manifold 10B.

### Embodiment 4 of Analysis Equipment and Flow Division Method with Flow Division Accessory

Referring to FIG. 6, the overall equipment and device of this embodiment are the same as that of Embodiment 3, except that the liquid sample S passes through the liquid chromatography column LC before being introduced into the four-way manifold 10B. The liquid chromatography column LC includes, but is not limited to, anion-, cation-, or amphoteric ion-sensitive chromatography columns, and through the anion or cation adsorption effect of the liquid chromatography column LC, the type and state of the various components of the liquid sample S can be further confirmed.

### <Validity Test>

Please refer to the following Table 1, which shows the results of the first analysis of the standard sample C using the aforementioned analysis equipment and flow division method with flow division accessory Embodiment 1, and the content of each element is about 1 ppb.

TABLE 1

| Types of elements in | Average |
|---|---|
| standard samples | concentration (ppb) |
| Na | 0.863 |
| Mg | 0.891 |
| Al | 0.927 |
| K | 0.85 |
| Ca | 0.808 |
| Cr | 0.926 |
| Mn | 0.933 |
| Fe | 0.854 |
| Ni | 0.992 |
| Co | 0.958 |
| Cu | 0.961 |
| Zn | 1.145 |
| Ag | 0.976 |
| Sn | 0.952 |

Referring to Table 2, the same liquid sample S is then introduced into the flow division accessory 10 of the present invention at different flow rates and tested by the analysis equipment to see whether the analysis results analyzed by the present invention at different flow rates are the same.

TABLE 2

| | Flow rate | Flow rate | |
|---|---|---|---|
| | 0.5 mL/min | 5 mL/min | |
| Element type | Average | Average | |
| in the | concentration | concentration | difference |
| liquid sample | (ppb) | (ppb) | (%) |
| Na | 1.059 | 1.034 | −2.4 |
| Mg | 0.858 | 0.858 | 0.0 |
| Al | 0.889 | 0.923 | 3.8 |
| K | 0.97 | 1.013 | 4.3 |
| Ca | 0.878 | 0.89 | 1.4 |
| Cr | 0.86 | 0.901 | 4.7 |
| Mn | 0.885 | 0.937 | 5.7 |
| Fe | 1.058 | 1.067 | 0.8 |
| Ni | 0.923 | 0.946 | 2.5 |
| Co | 0.896 | 0.941 | 4.9 |
| Cu | 0.973 | 1.005 | 3.2 |
| Zn | 0.952 | 0.949 | −0.3 |
| Ag | 0.862 | 0.878 | 1.8 |
| Sn | 0.872 | 0.85 | −2.6 |

From the above Tables 1 and 2, it can be seen that the content of each element in the liquid sample S is about 1 ppb, and the present invention uses two different flow rates of 0.5 mL/min and 5 mL/min to analyze, and all obtain the difference (%) is less than 5% of the minimal difference analysis results. Therefore, it can be confirmed that the flow division accessory of the present invention does not produce significant differences in the analysis results for different flow rates of the fed liquid sample S, it contains reproducibility and stability during the analysis method process.

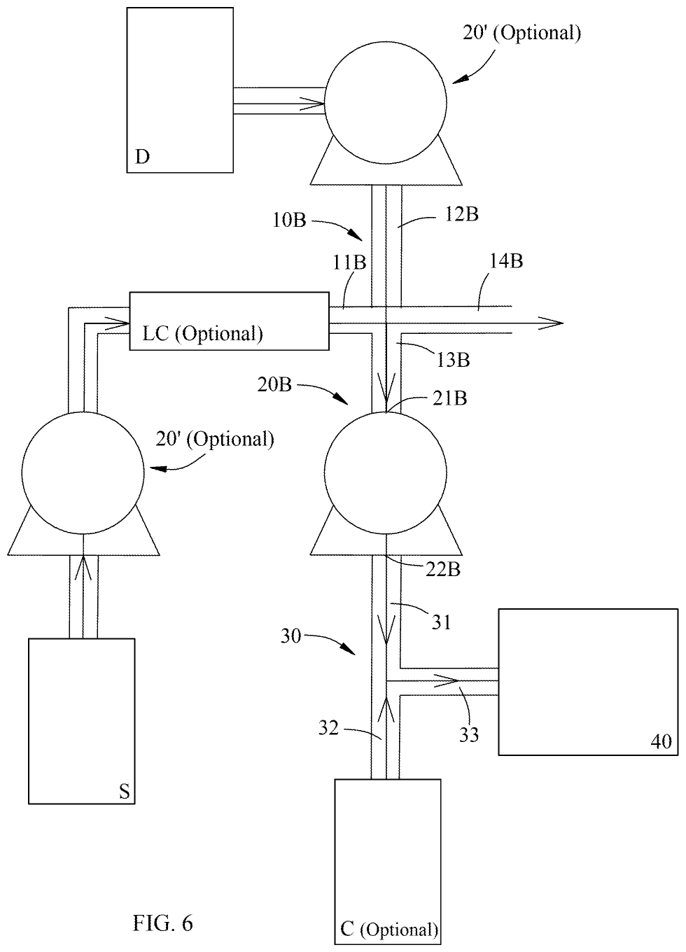

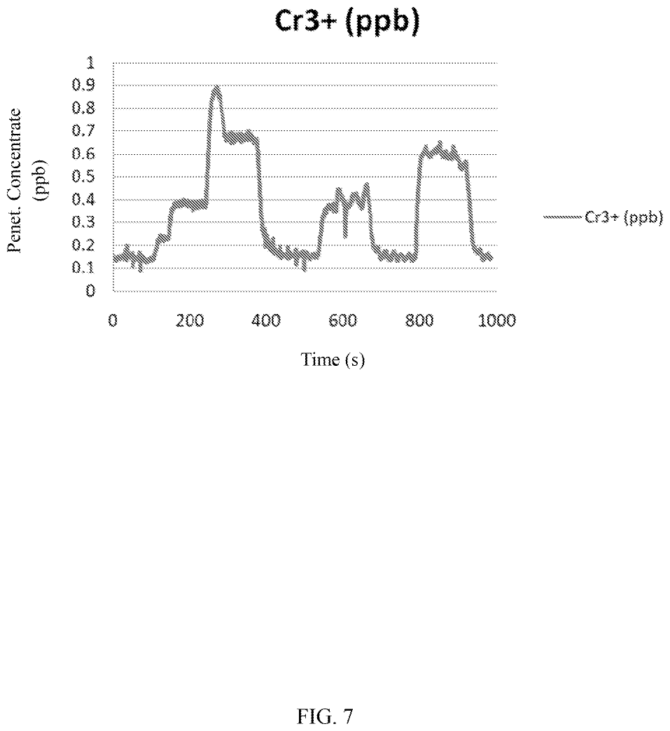

Referring to Tables 3-1˜3-4 below and FIG. 7, it is an example of the analysis of the extremely small amount of trivalent chromium (Cr³⁺) in the liquid sample S. The following analysis was performed by using the aforementioned analysis equipment and flow division method Embodiment 2 containing the liquid chromatography column LC with the flow division accessory. The liquid chromatography column LC used is a cationic column with the ability to adsorb trivalent chromium (Cr³⁺). This test is expected to truly reflect the effect of the adsorption of ions by the liquid chromatography column LC when the present invention is equipped with this liquid chromatography column LC, and its adsorption effect can be reflected in the analyzed metal ion content. Table 3-1 below shows the flow rate of the liquid sample S from 0 to 100 seconds at 1 mL/min.

In Table 3-1, the flow rate of the liquid sample S is 1 mL/min at 0˜100 seconds, and the analyzed content of the liquid sample S in the analysis equipment 40 is about 0.12˜0.15 ppb after passing through the liquid chromatography column LC, indicating that when the flow rate is low, the liquid chromatography column LC of the cationic column is able to adsorb the trivalent chromium in the liquid sample S more completely, thus making the analyzed content to be lower.

TABLE 3-1

| Time(s) | Cr³⁺ (ppb) |
|---|---|
| 1 | 0.153 |
| 2 | 0.143 |
| 3 | 0.147 |
| 4 | 0.138 |
| 5 | 0.142 |
| 6 | 0.138 |
| 7 | 0.145 |
| 8 | 0.141 |
| 9 | 0.134 |
| 10 | 0.144 |
| 11 | 0.142 |
| 12 | 0.147 |
| 13 | 0.142 |
| 14 | 0.150 |
| 15 | 0.150 |
| 16 | 0.146 |
| 17 | 0.144 |
| 18 | 0.142 |
| 19 | 0.142 |
| 20 | 0.154 |
| 21 | 0.147 |
| 22 | 0.148 |
| 23 | 0.147 |
| 24 | 0.152 |
| 25 | 0.156 |
| 26 | 0.150 |
| 27 | 0.153 |
| 28 | 0.146 |
| 29 | 0.146 |
| 30 | 0.139 |
| 31 | 0.149 |
| 32 | 0.157 |
| 33 | 0.149 |
| 34 | 0.135 |
| 35 | 0.153 |
| 36 | 0.121 |
| 37 | 0.157 |
| 38 | 0.169 |
| 39 | 0.153 |
| 40 | 0.150 |
| 41 | 0.153 |
| 42 | 0.153 |
| 43 | 0.152 |
| 44 | 0.151 |
| 45 | 0.148 |
| 46 | 0.150 |
| 47 | 0.149 |
| 48 | 0.146 |
| 49 | 0.143 |
| 50 | 0.149 |
| 51 | 0.156 |
| 52 | 0.110 |
| 53 | 0.151 |
| 54 | 0.151 |
| 55 | 0.147 |
| 56 | 0.137 |
| 57 | 0.136 |
| 58 | 0.140 |
| 59 | 0.147 |
| 60 | 0.149 |
| 61 | 0.147 |
| 62 | 0.142 |
| 63 | 0.147 |
| 64 | 0.147 |
| 65 | 0.140 |
| 66 | 0.142 |
| 67 | 0.137 |
| 68 | 0.145 |
| 69 | 0.157 |
| 70 | 0.157 |
| 71 | 0.192 |
| 72 | 0.123 |
| 73 | 0.151 |
| 74 | 0.151 |
| 75 | 0.150 |
| 76 | 0.150 |
| 77 | 0.153 |
| 78 | 0.152 |
| 79 | 0.146 |
| 80 | 0.145 |
| 81 | 0.139 |
| 82 | 0.140 |
| 83 | 0.133 |
| 84 | 0.134 |
| 85 | 0.130 |
| 86 | 0.128 |
| 87 | 0.134 |
| 88 | 0.136 |
| 89 | 0.136 |
| 90 | 0.138 |
| 91 | 0.130 |
| 92 | 0.140 |
| 93 | 0.137 |
| 94 | 0.141 |
| 95 | 0.134 |
| 96 | 0.137 |
| 97 | 0.146 |
| 98 | 0.140 |
| 99 | 0.135 |
| 100 | 0.134 |

In Table 3-2, the flow rate of the liquid sample S is 3 mL/min at 101˜242 seconds, and the analyzed content of the liquid sample S in the analysis equipment 40 is about 0.20˜0.40 ppb after passing through the liquid chromatography column LC, indicating that when the flow rate is increased, the liquid chromatography column LC of the cationic column is less able to completely adsorb the trivalent chromium in the liquid sample S. It is noteworthy that the concentration of trivalent chromium is gradually increased from 101 seconds to about 114 seconds due to the continuous feeding of the liquid sample S, this is the buffering time when the flow rate is increased.

TABLE 3-2

| Time(s) | Cr³⁺ (ppb) |
|---|---|
| 101 | 0.145 |
| 102 | 0.137 |
| 103 | 0.144 |
| 104 | 0.147 |
| 105 | 0.140 |
| 106 | 0.146 |
| 107 | 0.154 |
| 108 | 0.159 |
| 109 | 0.174 |
| 110 | 0.175 |
| 111 | 0.179 |
| 112 | 0.187 |
| 113 | 0.188 |
| 114 | 0.200 |
| 115 | 0.210 |
| 116 | 0.224 |
| 117 | 0.222 |
| 118 | 0.227 |
| 119 | 0.221 |
| 120 | 0.232 |
| 121 | 0.245 |
| 122 | 0.236 |
| 123 | 0.244 |
| 124 | 0.233 |
| 125 | 0.226 |
| 126 | 0.229 |
| 127 | 0.228 |
| 128 | 0.236 |
| 129 | 0.233 |
| 130 | 0.243 |
| 131 | 0.224 |
| 132 | 0.237 |
| 133 | 0.219 |
| 134 | 0.236 |
| 135 | 0.235 |
| 136 | 0.227 |
| 137 | 0.236 |
| 138 | 0.232 |
| 139 | 0.239 |
| 140 | 0.229 |
| 141 | 0.232 |
| 142 | 0.234 |
| 143 | 0.234 |
| 144 | 0.230 |
| 145 | 0.239 |
| 146 | 0.248 |
| 147 | 0.265 |
| 148 | 0.282 |
| 149 | 0.295 |
| 150 | 0.325 |
| 151 | 0.315 |
| 152 | 0.342 |
| 153 | 0.346 |
| 154 | 0.362 |
| 155 | 0.360 |
| 156 | 0.366 |
| 157 | 0.363 |
| 158 | 0.359 |
| 159 | 0.374 |
| 160 | 0.380 |
| 161 | 0.380 |
| 162 | 0.386 |
| 163 | 0.387 |
| 164 | 0.376 |
| 165 | 0.372 |
| 166 | 0.379 |
| 167 | 0.374 |
| 168 | 0.380 |
| 169 | 0.390 |
| 170 | 0.383 |
| 171 | 0.378 |
| 172 | 0.378 |
| 173 | 0.372 |
| 174 | 0.375 |
| 175 | 0.380 |
| 176 | 0.391 |
| 177 | 0.395 |
| 178 | 0.382 |
| 179 | 0.386 |
| 180 | 0.374 |
| 181 | 0.382 |
| 182 | 0.389 |
| 183 | 0.388 |
| 184 | 0.400 |
| 185 | 0.384 |
| 186 | 0.381 |
| 187 | 0.380 |
| 188 | 0.391 |
| 189 | 0.383 |
| 190 | 0.387 |
| 191 | 0.384 |
| 192 | 0.373 |
| 193 | 0.374 |
| 194 | 0.382 |
| 195 | 0.396 |
| 196 | 0.392 |
| 197 | 0.380 |
| 198 | 0.387 |
| 199 | 0.373 |
| 200 | 0.374 |
| 201 | 0.383 |
| 202 | 0.384 |
| 203 | 0.392 |
| 204 | 0.376 |
| 205 | 0.373 |
| 206 | 0.378 |
| 207 | 0.355 |
| 208 | 0.385 |
| 209 | 0.391 |
| 210 | 0.368 |
| 211 | 0.368 |
| 212 | 0.382 |
| 213 | 0.364 |
| 214 | 0.365 |
| 215 | 0.366 |
| 216 | 0.374 |
| 217 | 0.382 |
| 218 | 0.386 |
| 219 | 0.393 |
| 220 | 0.364 |
| 221 | 0.374 |
| 222 | 0.382 |
| 223 | 0.385 |
| 224 | 0.369 |
| 225 | 0.370 |
| 226 | 0.384 |
| 227 | 0.386 |
| 228 | 0.375 |
| 229 | 0.395 |
| 230 | 0.378 |
| 231 | 0.375 |
| 232 | 0.376 |
| 233 | 0.370 |
| 234 | 0.370 |
| 235 | 0.396 |
| 236 | 0.394 |
| 237 | 0.385 |
| 238 | 0.374 |
| 239 | 0.372 |
| 240 | 0.367 |
| 241 | 0.376 |
| 242 | 0.384 |

In Table 3-3, the flow rate of the liquid sample S is 6 mL/min at 243˜378 seconds, and the analyzed content of the liquid sample S in the analysis equipment 40 is about 0.60˜0.90 ppb after passing through the liquid chromatography column LC, indicating that when the flow rate is increased, the liquid chromatography column LC of the cationic column is less able to completely adsorb the trivalent chromium in the liquid sample S. It is noteworthy that the concentration of trivalent chromium is gradually increased from 243 seconds to about 378 seconds due to the continuous feeding of the liquid sample S, this is the buffering time when the flow rate is increased.

TABLE 3-3

| Time(s) | Cr³⁺ (ppb) |
|---|---|
| 243 | 0.424 |
| 244 | 0.435 |
| 245 | 0.467 |
| 246 | 0.514 |
| 247 | 0.553 |
| 248 | 0.591 |
| 249 | 0.638 |
| 250 | 0.674 |
| 251 | 0.709 |
| 252 | 0.739 |
| 253 | 0.772 |
| 254 | 0.788 |
| 255 | 0.805 |
| 256 | 0.828 |
| 257 | 0.844 |
| 258 | 0.845 |
| 259 | 0.849 |
| 260 | 0.863 |
| 261 | 0.863 |
| 262 | 0.875 |
| 263 | 0.869 |
| 264 | 0.870 |
| 265 | 0.868 |
| 266 | 0.866 |
| 267 | 0.888 |
| 268 | 0.881 |
| 269 | 0.874 |
| 270 | 0.894 |
| 271 | 0.882 |
| 272 | 0.884 |
| 273 | 0.884 |
| 274 | 0.867 |
| 275 | 0.849 |
| 276 | 0.856 |
| 277 | 0.851 |
| 278 | 0.858 |
| 279 | 0.837 |
| 280 | 0.830 |
| 281 | 0.809 |
| 282 | 0.798 |
| 283 | 0.788 |
| 284 | 0.774 |
| 285 | 0.768 |
| 286 | 0.741 |
| 287 | 0.746 |
| 288 | 0.708 |
| 289 | 0.708 |
| 290 | 0.687 |
| 291 | 0.690 |
| 292 | 0.678 |
| 293 | 0.682 |
| 294 | 0.687 |
| 295 | 0.660 |
| 296 | 0.684 |
| 297 | 0.682 |
| 298 | 0.659 |
| 299 | 0.676 |
| 300 | 0.680 |
| 301 | 0.677 |
| 302 | 0.666 |
| 303 | 0.681 |
| 304 | 0.675 |
| 305 | 0.672 |
| 306 | 0.663 |
| 307 | 0.692 |
| 308 | 0.648 |
| 309 | 0.649 |
| 310 | 0.674 |
| 311 | 0.650 |
| 312 | 0.677 |
| 313 | 0.685 |
| 314 | 0.670 |
| 315 | 0.665 |
| 316 | 0.652 |
| 317 | 0.652 |
| 318 | 0.685 |
| 319 | 0.661 |
| 320 | 0.671 |
| 321 | 0.683 |
| 322 | 0.664 |
| 323 | 0.675 |
| 324 | 0.667 |
| 325 | 0.669 |
| 326 | 0.667 |
| 327 | 0.684 |
| 328 | 0.682 |
| 329 | 0.664 |
| 330 | 0.685 |
| 331 | 0.685 |
| 332 | 0.653 |
| 333 | 0.672 |
| 334 | 0.663 |
| 335 | 0.685 |
| 336 | 0.676 |
| 337 | 0.679 |
| 338 | 0.660 |
| 339 | 0.676 |
| 340 | 0.660 |
| 341 | 0.675 |
| 342 | 0.673 |
| 343 | 0.677 |
| 344 | 0.684 |
| 345 | 0.675 |
| 346 | 0.662 |
| 347 | 0.661 |
| 348 | 0.663 |
| 349 | 0.672 |
| 350 | 0.661 |
| 351 | 0.685 |
| 352 | 0.702 |
| 353 | 0.680 |
| 354 | 0.685 |
| 355 | 0.672 |
| 356 | 0.663 |
| 357 | 0.674 |
| 358 | 0.662 |
| 359 | 0.670 |
| 360 | 0.688 |
| 361 | 0.675 |
| 362 | 0.679 |
| 363 | 0.669 |
| 364 | 0.662 |
| 365 | 0.660 |
| 366 | 0.656 |
| 367 | 0.651 |
| 368 | 0.661 |
| 369 | 0.668 |
| 370 | 0.648 |
| 371 | 0.656 |
| 372 | 0.656 |
| 373 | 0.654 |
| 374 | 0.648 |
| 375 | 0.665 |
| 376 | 0.649 |
| 377 | 0.628 |
| 378 | 0.607 |

In Table 3-4, at 279˜537 seconds, for showing the reproducibility of the present invention, the flow rate of the liquid sample S is set to 1 mL/min again, and at this time, the analyzed content of the liquid sample S in the analysis equipment 40 gradually decreased back to about 0.12˜0.15 ppb after passing through the liquid chromatography column LC, indicating that when the flow rate is low, the liquid chromatography column LC of the cationic column is able to adsorb the trivalent chromium in the liquid sample S more completely, thus making the analyzed content to be lower.

TABLE 3-4

| Time(s) | Cr³⁺ (ppb) |
|---|---|
| 379 | 0.565 |
| 380 | 0.518 |
| 381 | 0.498 |
| 382 | 0.455 |
| 383 | 0.418 |
| 384 | 0.409 |
| 385 | 0.384 |
| 386 | 0.354 |
| 387 | 0.326 |
| 388 | 0.318 |
| 389 | 0.293 |
| 390 | 0.270 |
| 391 | 0.261 |
| 392 | 0.261 |
| 393 | 0.242 |
| 394 | 0.248 |
| 395 | 0.258 |
| 396 | 0.270 |
| 397 | 0.219 |
| 398 | 0.194 |
| 399 | 0.219 |
| 400 | 0.246 |
| 401 | 0.235 |
| 402 | 0.237 |
| 403 | 0.221 |
| 404 | 0.212 |
| 405 | 0.215 |
| 406 | 0.203 |
| 407 | 0.200 |
| 408 | 0.192 |
| 409 | 0.183 |
| 410 | 0.185 |
| 411 | 0.177 |
| 412 | 0.158 |
| 413 | 0.157 |
| 414 | 0.154 |
| 415 | 0.154 |
| 416 | 0.132 |
| 417 | 0.157 |
| 418 | 0.154 |
| 419 | 0.150 |
| 420 | 0.154 |
| 421 | 0.151 |
| 422 | 0.158 |
| 423 | 0.156 |
| 424 | 0.155 |
| 425 | 0.151 |
| 426 | 0.150 |
| 427 | 0.153 |
| 428 | 0.151 |
| 429 | 0.151 |
| 430 | 0.157 |
| 431 | 0.151 |
| 432 | 0.151 |
| 433 | 0.155 |
| 434 | 0.152 |
| 435 | 0.159 |
| 436 | 0.157 |
| 437 | 0.154 |
| 438 | 0.144 |
| 439 | 0.159 |
| 440 | 0.159 |
| 441 | 0.152 |
| 442 | 0.159 |
| 443 | 0.156 |
| 444 | 0.150 |
| 445 | 0.150 |
| 446 | 0.155 |
| 447 | 0.150 |
| 448 | 0.158 |
| 449 | 0.156 |
| 450 | 0.156 |
| 451 | 0.158 |
| 452 | 0.156 |
| 453 | 0.155 |
| 454 | 0.150 |
| 455 | 0.152 |
| 456 | 0.154 |
| 457 | 0.143 |
| 458 | 0.142 |
| 459 | 0.174 |
| 460 | 0.170 |
| 461 | 0.160 |
| 462 | 0.157 |
| 463 | 0.156 |
| 464 | 0.159 |
| 465 | 0.163 |
| 466 | 0.150 |
| 467 | 0.157 |
| 468 | 0.158 |
| 469 | 0.154 |
| 470 | 0.155 |
| 471 | 0.150 |
| 472 | 0.153 |
| 473 | 0.151 |
| 474 | 0.149 |
| 475 | 0.159 |
| 476 | 0.151 |
| 477 | 0.119 |
| 478 | 0.138 |
| 479 | 0.155 |
| 480 | 0.158 |
| 481 | 0.159 |
| 482 | 0.154 |
| 483 | 0.159 |
| 484 | 0.153 |
| 485 | 0.155 |
| 486 | 0.155 |
| 487 | 0.157 |
| 488 | 0.154 |
| 489 | 0.152 |
| 490 | 0.157 |
| 491 | 0.150 |
| 492 | 0.151 |
| 493 | 0.152 |
| 494 | 0.153 |
| 495 | 0.153 |
| 496 | 0.157 |
| 497 | 0.146 |
| 498 | 0.135 |
| 499 | 0.147 |
| 500 | 0.151 |
| 501 | 0.159 |
| 502 | 0.151 |
| 503 | 0.154 |
| 504 | 0.159 |
| 505 | 0.158 |
| 506 | 0.156 |
| 507 | 0.154 |
| 508 | 0.151 |
| 509 | 0.156 |
| 510 | 0.146 |
| 511 | 0.145 |
| 512 | 0.144 |
| 513 | 0.138 |
| 514 | 0.145 |
| 515 | 0.142 |
| 516 | 0.149 |
| 517 | 0.150 |
| 518 | 0.152 |
| 519 | 0.150 |
| 520 | 0.151 |
| 521 | 0.150 |
| 522 | 0.150 |
| 523 | 0.150 |
| 524 | 0.154 |
| 525 | 0.152 |
| 526 | 0.157 |
| 527 | 0.148 |
| 528 | 0.149 |
| 529 | 0.151 |
| 530 | 0.146 |
| 531 | 0.147 |
| 532 | 0.153 |
| 533 | 0.158 |
| 534 | 0.156 |
| 535 | 0.159 |
| 536 | 0.153 |
| 537 | 0.153 |

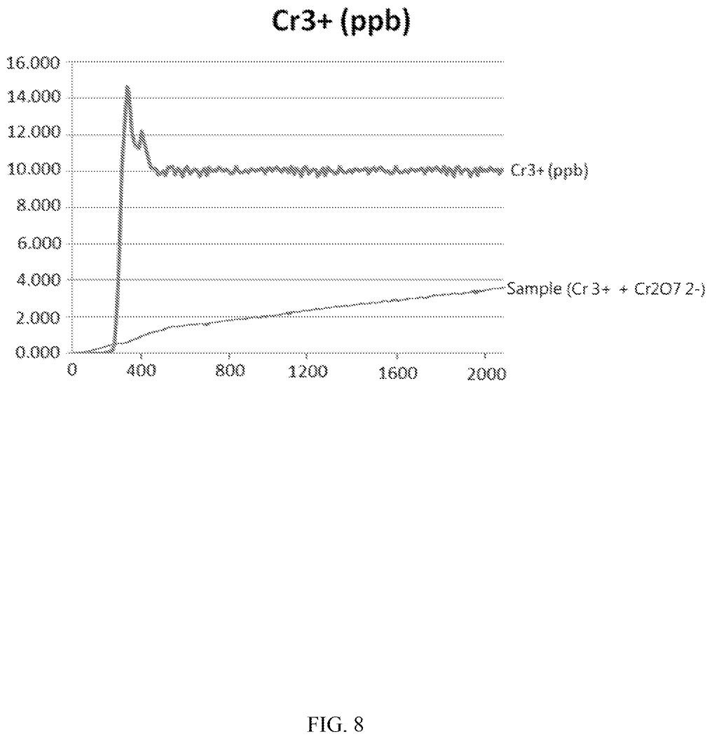

Referring to Table 4 below and FIG. 8, the analysis is performed using the aforementioned analysis equipment and flow division method with flow division accessory Embodiment 2 which contains the liquid chromatography column LC, and performs the analysis with the liquid sample S containing both trivalent chromium (Cr³⁺) and chromate (Cr₂O₇²⁻), and the standard C as a standard solution (Cr³⁺ in 1% HNO₃) of trivalent chromium (Cr³⁺). The liquid chromatography column LC used is an anion column with the ability to adsorb chromate anions. As shown in Table 4, the concentration of trivalent chromium (Cr³⁺) ions in S is analyzed to be in the range of 2˜4 ppb because chromate (Cr₂O₇²⁻) is adsorbed by the anion column, while the concentration of trivalent chromium (Cr³⁺) standard solution is 9˜10 ppm as expected because it was not adsorbed by the anion column. With the liquid chromatography column LC, it is not only possible to analyze the chromium component in different states in real-time, but also it will not affect the subsequent analysis of the analysis equipment 40 at different flow rates of the liquid sample S.

TABLE 4

| Time (s) | Cr₂O₇²⁻(ppb) | Cr³⁺ (ppb) |
|---|---|---|
| 10.8 | 0.002 | 0.001 |
| 21.6 | 0.003 | 0.001 |
| 32.4 | 0.007 | 0.001 |
| 43.2 | 0.011 | 0.002 |
| 54 | 0.024 | 0.003 |
| 64.8 | 0.038 | 0.005 |
| 75.6 | 0.064 | 0.010 |
| 86.4 | 0.075 | 0.012 |
| 97.2 | 0.112 | 0.015 |
| 108 | 0.144 | 0.015 |
| 118.8 | 0.185 | 0.013 |
| 129.6 | 0.211 | 0.018 |
| 140.4 | 0.239 | 0.023 |
| 151.2 | 0.284 | 0.035 |
| 162 | 0.317 | 0.055 |
| 172.8 | 0.355 | 0.090 |
| 183.6 | 0.398 | 0.193 |
| 194.4 | 0.412 | 0.555 |
| 205.2 | 0.438 | 2.705 |
| 216 | 0.474 | 6.520 |
| 226.8 | 0.488 | 10.055 |
| 237.6 | 0.465 | 12.440 |
| 248.4 | 0.514 | 14.620 |
| 259.2 | 0.517 | 14.223 |
| 270 | 0.606 | 12.211 |
| 280.8 | 0.651 | 11.522 |
| 291.6 | 0.693 | 11.414 |
| 302.4 | 0.754 | 11.228 |
| 313.2 | 0.808 | 12.168 |
| 324 | 0.883 | 11.761 |
| 334.8 | 0.890 | 11.129 |
| 345.6 | 0.951 | 10.549 |
| 356.4 | 1.024 | 10.230 |
| 367.2 | 1.028 | 10.137 |
| 378 | 1.086 | 10.123 |
| 388.8 | 1.089 | 9.834 |
| 399.6 | 1.140 | 9.869 |
| 410.4 | 1.139 | 10.020 |
| 421.2 | 1.203 | 9.757 |
| 432 | 1.249 | 10.229 |
| 442.8 | 1.292 | 10.201 |
| 453.6 | 1.304 | 10.258 |
| 464.4 | 1.343 | 9.829 |
| 475.2 | 1.311 | 10.165 |
| 486 | 1.353 | 10.085 |
| 496.8 | 1.346 | 9.718 |
| 507.6 | 1.395 | 10.159 |
| 518.4 | 1.395 | 10.242 |
| 529.2 | 1.422 | 9.866 |
| 540 | 1.427 | 10.009 |
| 550.8 | 1.425 | 10.100 |
| 561.6 | 1.444 | 10.078 |
| 572.4 | 1.476 | 9.738 |
| 583.2 | 1.471 | 9.953 |
| 594 | 1.476 | 10.153 |
| 604.8 | 1.383 | 9.775 |
| 615.6 | 1.495 | 10.199 |
| 626.4 | 1.520 | 10.003 |
| 637.2 | 1.538 | 10.072 |
| 648 | 1.536 | 10.027 |
| 658.8 | 1.572 | 10.206 |
| 669.6 | 1.600 | 10.098 |
| 680.4 | 1.609 | 10.027 |
| 691.2 | 1.619 | 10.104 |
| 702 | 1.655 | 10.024 |
| 712.8 | 1.641 | 9.854 |
| 723.6 | 1.682 | 9.900 |
| 734.4 | 1.685 | 10.238 |
| 745.2 | 1.714 | 10.030 |
| 756 | 1.675 | 9.934 |
| 766.8 | 1.714 | 9.968 |
| 777.6 | 1.700 | 10.041 |
| 788.4 | 1.779 | 9.934 |
| 799.2 | 1.764 | 10.105 |
| 810 | 1.809 | 10.116 |
| 820.8 | 1.843 | 10.029 |
| 831.6 | 1.794 | 10.043 |
| 842.4 | 1.772 | 10.109 |
| 853.2 | 1.874 | 10.174 |
| 864 | 1.806 | 9.862 |
| 874.8 | 1.886 | 10.128 |
| 885.6 | 1.897 | 10.209 |
| 896.4 | 1.843 | 10.011 |
| 907.2 | 1.915 | 10.155 |
| 918 | 1.913 | 10.229 |
| 928.8 | 1.938 | 10.039 |
| 939.6 | 1.982 | 9.952 |
| 950.4 | 1.968 | 10.181 |
| 961.2 | 2.050 | 10.105 |
| 972 | 1.953 | 9.929 |
| 982.8 | 2.083 | 10.258 |
| 993.6 | 2.081 | 9.829 |
| 1004.4 | 2.073 | 10.165 |
| 1015.2 | 2.085 | 10.085 |
| 1026 | 2.123 | 9.718 |
| 1036.8 | 2.151 | 10.159 |
| 1047.6 | 2.142 | 10.242 |
| 1058.4 | 2.154 | 9.866 |
| 1069.2 | 2.203 | 10.009 |
| 1080 | 2.177 | 10.100 |
| 1090.8 | 2.259 | 10.078 |
| 1101.6 | 2.210 | 9.738 |
| 1112.4 | 2.237 | 9.953 |
| 1123.2 | 2.250 | 10.153 |
| 1134 | 2.296 | 9.775 |
| 1144.8 | 2.284 | 10.199 |
| 1155.6 | 2.317 | 10.003 |
| 1166.4 | 2.322 | 10.024 |
| 1177.2 | 2.366 | 9.854 |
| 1188 | 2.322 | 9.900 |
| 1198.8 | 2.368 | 10.238 |
| 1209.6 | 2.369 | 10.030 |
| 1220.4 | 2.417 | 9.934 |
| 1231.2 | 2.366 | 9.968 |
| 1242 | 2.397 | 10.041 |
| 1252.8 | 2.428 | 9.934 |
| 1263.6 | 2.458 | 10.105 |
| 1274.4 | 2.449 | 10.116 |
| 1285.2 | 2.532 | 10.029 |
| 1296 | 2.476 | 10.043 |
| 1306.8 | 2.493 | 10.109 |
| 1317.6 | 2.489 | 10.174 |
| 1328.4 | 2.550 | 9.862 |
| 1339.2 | 2.566 | 10.128 |
| 1350 | 2.519 | 10.209 |
| 1360.8 | 2.562 | 10.011 |
| 1371.6 | 2.561 | 10.155 |
| 1382.4 | 2.649 | 10.229 |
| 1393.2 | 2.642 | 10.039 |
| 1404 | 2.595 | 9.952 |
| 1414.8 | 2.596 | 10.024 |
| 1425.6 | 2.685 | 9.854 |
| 1436.4 | 2.719 | 9.900 |
| 1447.2 | 2.620 | 10.238 |
| 1458 | 2.686 | 10.030 |
| 1468.8 | 2.691 | 9.934 |
| 1479.6 | 2.682 | 9.968 |
| 1490.4 | 2.785 | 10.041 |
| 1501.2 | 2.759 | 9.934 |
| 1512 | 2.773 | 10.105 |
| 1522.8 | 2.762 | 10.116 |
| 1533.6 | 2.766 | 10.029 |
| 1544.4 | 2.840 | 10.043 |
| 1555.2 | 2.845 | 10.109 |
| 1566 | 2.780 | 10.174 |
| 1576.8 | 2.807 | 9.862 |
| 1587.6 | 2.885 | 10.128 |
| 1598.4 | 2.872 | 10.209 |
| 1609.2 | 2.955 | 10.011 |
| 1620 | 2.912 | 10.155 |
| 1630.8 | 2.934 | 10.229 |
| 1641.6 | 2.929 | 10.039 |
| 1652.4 | 2.994 | 9.952 |
| 1663.2 | 2.953 | 10.258 |
| 1674 | 2.966 | 9.829 |
| 1684.8 | 3.016 | 10.165 |
| 1695.6 | 3.041 | 10.085 |
| 1706.4 | 3.005 | 9.718 |
| 1717.2 | 2.989 | 10.159 |
| 1728 | 2.991 | 10.242 |
| 1738.8 | 3.065 | 9.866 |
| 1749.6 | 3.052 | 10.009 |
| 1760.4 | 3.068 | 10.100 |
| 1771.2 | 3.095 | 10.078 |
| 1782 | 3.173 | 9.738 |
| 1792.8 | 3.025 | 9.953 |
| 1803.6 | 3.186 | 10.153 |
| 1814.4 | 3.110 | 9.775 |
| 1825.2 | 3.173 | 10.199 |
| 1836 | 3.216 | 10.003 |
| 1846.8 | 3.202 | 10.072 |
| 1857.6 | 3.259 | 10.027 |
| 1868.4 | 3.279 | 10.206 |
| 1879.2 | 3.277 | 10.098 |
| 1890 | 3.273 | 10.027 |
| 1900.8 | 3.293 | 10.104 |
| 1911.6 | 3.332 | 9.862 |
| 1922.4 | 3.348 | 10.128 |

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A flow division accessory used in analysis equipment, which comprises:
a three-way manifold, which contains a feeding line connected to the fluid, a first discharging line, and a second discharging line; and
a pumping device contains a feeding port and a discharging port, the feeding port and the second discharging line are in liquid communication.

2. A flow division accessory used in analysis equipment, which comprises:
a four-way manifold, which contains a first feeding line connected to the fluid, a second feeding line, a first discharging line, and a second discharging line; and
a pumping device contains a feeding port and a discharging port, the feeding port and the second discharging line are in liquid communication.

3. The flow division accessory used in analysis equipment according to claim 1,
wherein: the pumping device comprises a diaphragm pump, peristaltic pump, piston pump, or ventilator tube.

4. The flow division accessory used in analysis equipment according to claim 2, wherein: the pumping device comprises a diaphragm pump, peristaltic pump, piston pump, or ventilator tube.

5. The flow division accessory used in analysis equipment according to claim 1, wherein: another pumping device and/or a liquid chromatography column is set in front of the feeding line or the first feeding line, the pumping device comprising a diaphragm pump, a peristaltic pump, a piston pump, a ventilator tube, or a pressure cylinder.

6. The flow division accessory used in analysis equipment according to claim 2, wherein: another pumping device and/or a liquid chromatography column is set in front of the feeding line or the first feeding line, the pumping device comprising a diaphragm pump, a peristaltic pump, a piston pump, a ventilator tube, or a pressure cylinder.

7. The flow division accessory used in analysis equipment according to claim 5, the liquid chromatography column comprising an anion-, cation-, or amphoteric ion-sensitive chromatography column.

8. An analysis equipment, equipped with the flow division accessory as claimed in claim 1.

9. The analysis equipment according to claim 5, wherein: the analysis equipment comprises an inductively coupled plasma mass spectrometer.

10. A flow division method, in which the steps comprise:
equipping a flow division accessory as described in any of claim 1, to the front of analysis equipment;
introducing a liquid sample from the feeding line of the three-way manifold into the feed line;
the pumping device presetting a feeding volume, some of the liquid sample being led into the first discharging line and into the pumping device, and the remaining liquid sample being let out of the second discharging line; and
the pre-set amount of the liquid sample is pumped from the feeding port of the pumping device and discharged from the discharging port into another three-way manifold, which comprises a first three-way feeding line, a second three-way feeding line, and a three-way discharging line, and the liquid sample being led from the discharging port into the first three-way feeding line and then through the three-way discharging line to the analysis equipment for analysis.

11. A flow division method, in which the steps comprise:
equipping a flow division accessory as described in any of claim 2, to the front of analysis equipment;
introducing a liquid sample from the first feeding line of the four-way manifold;
introducing a diluent from the second feeding line of the four-way manifold;
the pumping device presetting a feeding volume, some of the liquid sample and the diluent being led into the first discharging line and into the pumping device, and the remaining liquid sample and diluent being let out of the second discharging line; and
the pre-set amount of the diluted liquid sample is pumped from the feeding port of the pumping device and discharged from the discharging port into another three-way manifold, which comprises a first three-way feeding line, a second three-way feeding line, and a three-way discharging line, and the diluted liquid sample being led from the discharging port into the first three-way feeding line and then through the three-way discharging line to the analysis equipment for analysis.

12. The flow division method according to claim 10, wherein: the value differences between the flow rate or pressure value of the liquid sample in the first discharging line and the flow rate or pressure value of the liquid sample from the discharging port into the first three-way feeding line remain similar or equal.

13. The flow division method according to claim 11, wherein: the value differences between the flow rate or pressure value of the liquid sample in the first discharging line and the flow rate or pressure value of the liquid sample from the discharging port into the first three-way feeding line remain similar or equal.

14. The flow division method according to claim 10, wherein: before analyzing the liquid sample, one or several standard samples are introduced through the second three-way feeding line, and then through the three-way discharging line into the analysis equipment to produce a Calibration curve; at the same time, a switching valve is provided at the junction of the first three-way feeding line and the second three-way feeding line to selectively allow only the liquid sample or the standard sample to pass through the three-way discharging line and enter the analysis equipment for analysis.

15. The flow division method according to claim 11, wherein: before analyzing the liquid sample, one or several standard samples are introduced through the second three-way feeding line, and then through the three-way discharging line into the analysis equipment to produce a Calibration curve; at the same time, a switching valve is provided at the junction of the first three-way feeding line and the second three-way feeding line to selectively allow only the liquid sample or the standard sample to pass through the three-way discharging line and enter the analysis equipment for analysis.
